(19) United States
(12) Patent Application Publication
(10) Pub. No.: US 2012/0104198 A1
(43) Pub. Date: May 3, 2012

(54) MAGNETIC ORGANIZER

(75) Inventors: Charles M. Phillips, SR., Zelienople, PA (US); Mark P. Noah, Butler, PA (US); Donald B. Roth, Cabot, PA (US); Mark J. Spiering, Leechburg, PA (US); Thomas W. Lasher, Adrian, PA (US); Matthew F. Muir, Butler, PA (US); James A. Shreckengost, Adrian, PA (US)

(73) Assignee: PENN UNITED TECHNOLOGIES, INC., CABOT, PA (US)

(21) Appl. No.: 13/343,081

(22) Filed: Jan. 4, 2012

Related U.S. Application Data
(63) Continuation of application No. 12/178,937, filed on Jul. 24, 2008.
Application No. 12/178,937 is a continuation-in-part of application No. 12/109,015, filed on Apr. 24, 2008, now abandoned.

(51) Int. Cl. F16M 13/02; H01F 7/02

(52) U.S. Cl. 248/206.5

(57) ABSTRACT

A magnetic organizer is provided that includes cooperative magnetic members, one generally planar member and one support assembly having a magnetic member, and including one or more horizontally-extending protuberances on the generally planar member.

### CROSS REFERENCE TO RELATED APPLICATION

This application is a continuation of U.S. patent application Ser. No. 12/178,937, filed Jul. 24, 2008, entitled MAGNETIC ORGANIZER, which application claims priority under 35 U.S.C. §119(e) to U.S. patent application Ser. No. 12/109,015, filed Apr. 24, 2008, entitled MAGNETIC ORGANIZER.

### BACKGROUND OF THE INVENTION

1. Field of the Invention

This invention relates to a vertical, panel-like organizer structured to have movable supports coupled thereto, and more specifically, to a magnetic organizer having a generally planar magnetic member with movable support assemblies coupled thereto, the generally planar magnetic member has at least one horizontally extending protuberance on an attachment surface. Further, the support assemblies are structured to include a clamp assembly that engages the at least one horizontally extending protuberance in a clamping manner.

2. Background Information

Vertical organizers are devices structured to support various items along a vertical surface. Of course, vertical organizers require an attaching means structured to support each item in its vertical position. Thus, in perhaps its most primitive form, a vertical organizer includes a series of pegs or nails extending from a vertical wall. The user could then hang tools of an appropriate shape, e.g., the curved side of a claw hammer, or tools with an appropriately-positioned hole or loop of material, from the peg.

While simple and functional, a fixed-peg system had the disadvantage of not being adjustable. This could limit the number of tools, and their positions, stored on the organizer. There are at least two improvements that overcome this difficulty; pegboards and magnetic strips, both of which are typically coupled to a wall. A pegboard is a sheet of material having a series of holes therethrough. The holes are typically disposed in a grid or other regular pattern. A “peg” may be inserted into a hole and used to store a tool or other device. Typically, a peg included a portion that extended along the pegboard, along with two bent tips structured to be inserted into the holes, and another portion that extended generally perpendicular to the pegboard. If the user needed to make more room or just wanted to reposition the tool, the user simply removed the peg from its first hole(s) and inserted the peg in another. Further, the “pegs” could easily be adapted to store different types of tools. For example, a peg could be bent into a horizontal loop and used to store screwdrivers and other elongated tools, a peg could be split into a yoke and used to support hammers or similar tools, a peg could be a U-shaped hook, or otherwise adapted to a specific tool. While pegboards are adjustable, the process of moving the pegs can be time consuming. For example, a user may shift a series of pegs to one side to accommodate a new tool. However, after placing the new tool in its place, the user may discover the pegs are still too close, and the process has to be repeated.

Magnetic organizers typically have an elongated, permanent magnet disposed between two steel, or other ferrous metal, plates. The thin edges of the plates are used as magnetic coupling surfaces. Often, two such devices were disposed in a spaced relationship. The devices typically extended generally horizontally. A user may attach any ferrous tool to the exposed edges of the plates. With such a magnetic device, a user may quickly shift the tools around in order to accommodate new tools. The disadvantage to this device is that it typically extends for a limited length, thereby limiting the number of tools that may be attached. Further, because the plates and/or different devices are held in a spaced relationship, the user cannot, for example, move the tools to a different vertical location on the wall. Further, while the device is, by its nature, limited to ferrous tools, even a small amount of plastic, such as a coating on a handle, could diminish the attraction between the magnet and the tool to a point where the magnetic force is insufficient to hold the tool to the magnet. While the magnetic attraction could be increased by using stronger magnets, such stronger magnets are expensive.

One attempt to combine the best features of these two systems is to provide a ferromagnetic sheet and supports, e.g., “pegs” of various shapes, having a ferromagnetic base. That is, at least one of the two components, either a sheet or the base of the supports, was a magnet. The other was either another magnet or, more typically, a ferrous material. Such a device addressed the disadvantages of the prior two devices. Like a pegboard, the supports could be moved to any location on the sheet, including different vertical locations; but, like a magnetic organizer, the user could simply attach/detach a support and not have inserted pegs into holes.

Unfortunately, this configuration was not optimal either. While the magnets were typically strong enough to resist being separated from the sheet, the magnets did not have enough attraction to prevent the support from sliding down the sheet. That is, the magnets could not prove a sufficient magnetic attraction to create a high starting friction between the sheet and the support base. Thus, the support would slide down the sheet. This was especially true when a mass, typically a tool, was coupled to the support.

### SUMMARY OF THE INVENTION

The present invention overcomes this problem by providing cooperative magnetic members, one generally planar member, and at least one support assembly having a magnetic member, and including one or more horizontally-extending protuberances on the generally planar member. The protuberances create a non-vertical surface that at least some portion of the support assemblies may catch upon, thereby preventing downward sliding.

It is noted that any two objects placed in contact with each other have a “starting friction” that must be overcome prior to the two objects sliding against each other. Once objects are in motion, a “sliding friction” exists therebetween. The force required to overcome the starting friction is always higher than the force required to overcome the sliding friction. Typically, both the starting friction and the sliding friction may be increased by increasing the coarseness of the two objects. For example, it is easier to slide two sheets of plain paper against each other than it is to slide two pieces of sandpaper against each other. Further, starting friction is increased and therefore the force required to overcome the starting friction is increased, when the objects are biased or pressed together. Again, using sheets of paper as an example, if one person was to hold three sheets of paper between their thumb and forefinger and apply minimal force, another person could remove the middle sheet of paper with ease. This is because there is a minimal starting friction between the sheets of paper; however, if the person holding the paper were to greatly increase the force applied by their thumb and forefinger, the person removing the middle sheet would have to pull harder as the starting friction is greatly increased.

The strength of a magnetic attraction relates to both the strength of the magnet and the distance to the ferrous object. Further, even a slight increase in distance between the magnet and the object will greatly reduce the strength of the magnetic attraction. Thus, when coupling two objects by magnetic attraction, it is best to have as much of the surface of the two magnetically attracted objects as close together as possible, and more preferably in contact with each other. Accordingly, most magnets and the surface to which they are attached are smooth, thereby increasing the surface area in contact; but, as noted above, smooth surfaces tend to have a lower starting/sliding friction. Thus, while an increased magnetic force acts to increase the starting friction, that is, the magnetic force is similar to pressing the magnet against the surface, this increase in starting friction is not always so great as to prevent the magnet from sliding on a ferrous surface. This is especially true as the inclination of the surface becomes more vertical and/or the weight of the magnet, or any object the magnet supports, increases.

The present invention overcomes the problem of sliding by providing one or more protuberances on the sheet. The protuberances have a sufficient perpendicular offset so that the support assembly must be lifted off the sheet in order to move past the protuberance. That is, as noted above, many magnetic devices have a sufficient strength to support the weight of a tool, i.e., the magnet device will not detach from a ferrous surface due to the weight of the tool, but not enough strength to prevent sliding on a vertical surface. Thus, when a protuberance has a sufficient perpendicular offset, the support assembly must be lifted off the sheet in order to move past the protuberance.

In a further embodiment, the at least one support assembly includes a separate support assembly base and support assembly support arm, which are coupled by a hinge. In this embodiment, the support assembly base, support assembly hinge, and support assembly support arm form a clamp assembly. The clamp assembly is structured to engage the at least one horizontally extending protuberance in a clamping manner. Preferably, the at least one horizontally extending protuberance has an inwardly angled upper surface and an inwardly angled lower surface. This “double taper ridge” is structured to be clamped by the clamping assembly. In this embodiment, both the magnetic member and the clamp assembly couple the at least one support assembly to a planar magnetic member.

An enhancement of this embodiment allows for the removal of the magnetic aspect of the organizer. That is, if the angled upper surface of the double taper ridge is sufficiently acute, the at least one support assembly will not be able to slide over the surface of the upper surface of the double taper ridge. Thus, the clamp assembly provides a sufficient coupling force and the magnetic coupling is not required. The coupling force of the clamp assembly may also be enhanced by a spring structured to bias the clamp assembly to a closed position.

Other enhancements include a clamp assembly bias device structured to bias the clamp assembly to a closed position for when the clamp is coupled to the double taper ridge. The clamp assembly bias device may, for example, be one or more magnets in the clamp assembly members structured to magnetically couple the clamp assembly elements to the generally planar magnetic member or a spring structured to bias the clamp assembly to the closed position.

### BRIEF DESCRIPTION OF THE DRAWINGS

A full understanding of the invention can be gained from the following description of the preferred embodiments when read in conjunction with the accompanying drawings in which:

FIG. 1 is an isometric view of a magnetic organizer;

FIG. 2 is a side view of the magnetic organizer;

FIG. 3 is a partial, cross-sectional side view of one embodiment of the magnetic organizer;

FIG. 4 is an isometric view of another embodiment of a support assembly;

FIG. 5 is an isometric view of an alternate embodiment of the magnetic organizer, wherein a support assembly has a clamp assembly and wherein the clamp assembly is in an open, first position;

FIG. 6 is an isometric view of an alternate embodiment of the magnetic organizer, wherein a support assembly has a clamp assembly and wherein the clamp assembly is in an closed, second position;

FIG. 7 is a side view of the alternate embodiment of the support assembly which has a clamp assembly and wherein the clamp assembly is in an open, first position;

FIG. 8 is a side view of the alternate embodiment of the support assembly which has a clamp assembly and wherein the clamp assembly is in a closed, second position;

FIG. 8 is a cross-sectional view of a support assembly having a magnetic bias device on the clamp assembly;

FIG. 10 is a cross-sectional view of a support assembly having a spring bias device on the clamp assembly;

FIG. 11A is a side view of a support assembly having a spring bias device on the clamp assembly and a positioning device; FIG. 11B is a back side view of the support assembly of FIG. 11A; FIG. 11C is a detail view of a positioning device.

### DESCRIPTION OF THE PREFERRED EMBODIMENTS

As used herein, “generally planar” is used in a broad sense meaning an object having a thickness that is substantially smaller than the object's length and/or width and which generally defines a plane. It is specifically noted that “generally planar” does not mean substantially flat as one object of this invention is to provide a “generally planar” member having protuberances on an attachment surface.

As used herein, a “magnetic member” is either a member that is attracted to iron or steel, e.g., a typical magnet, or an iron or steel member to which a magnet is attracted. Further, when two “magnetic members” are identified as “cooperative,” it means that at least one magnetic member is attracted to iron or steel. That is, for example, two steel members may each be “magnetic members,” but are not “cooperative magnetic members” as neither member would be attracted to the other.

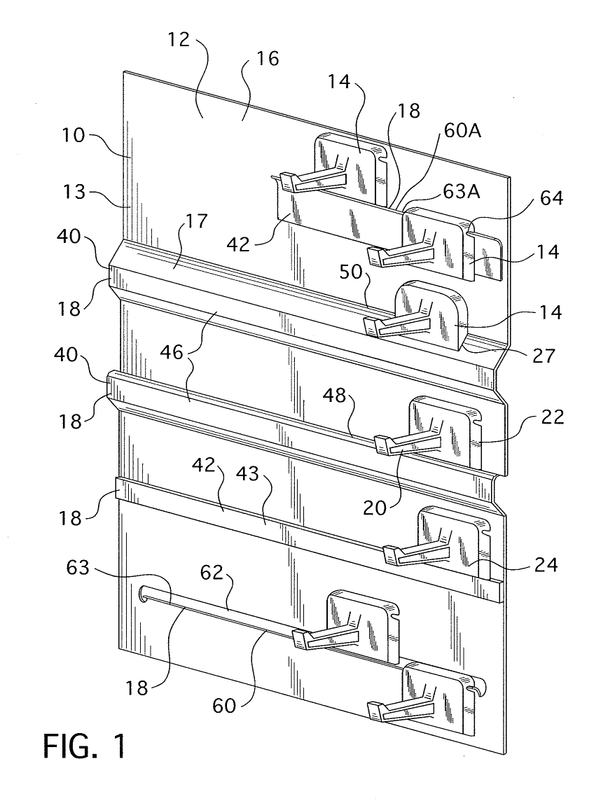

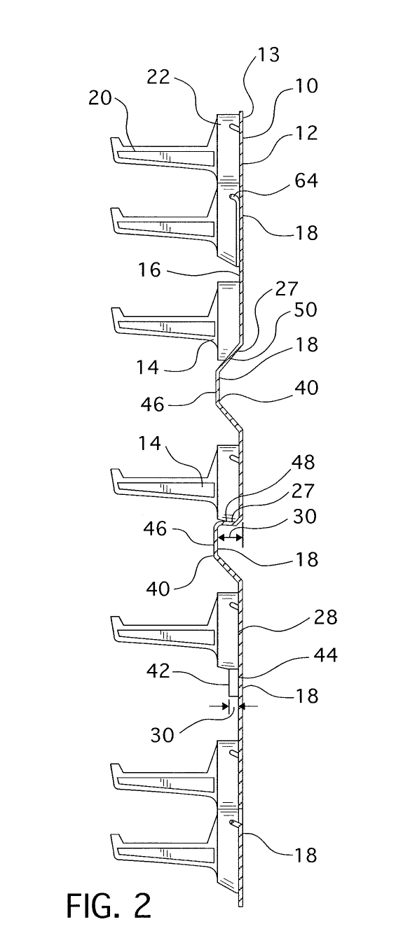

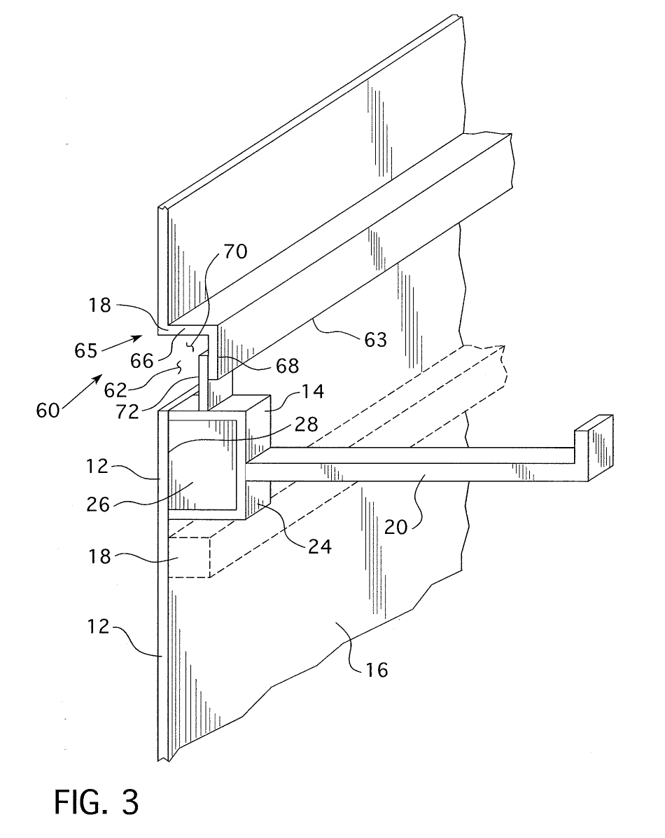

As shown in FIGS. 1 and 2, a magnetic organizer 10 includes a generally planar magnetic member 12 and at least one support assembly 14. The generally planar magnetic member 12 has an outer attachment surface 16 and is disposed in a generally vertical plane. The outer attachment surface 16 has at least one protuberance 18 thereon, which will be discussed in greater detail below. As noted above, a “magnetic member” 12 may be either a member that is attracted to iron or steel, e.g., a typical magnet, or an iron or steel member to which a magnet is attracted. In the preferred embodiment, the generally planar magnetic member 12 is a sheet 13 of ferrous metal and the at least one support assembly magnetic member 26 (FIG. 3), discussed below, is a magnet. While the claims are not so limited, the remainder of this discussion will utilize this configuration of the magnetic members 12, 26. The sheet 13, except for any protuberances 18, is preferably generally flat and defines a plane.

The at least one support assembly 14 includes a support arm 20 and a base 22. The support arm 20 extends from the base 22. Preferably, the at least one support assembly 14 includes a moldable shell, such as, but not limited to, a plastic shell 24. The plastic shell 24 defines the support arm 20 and a base 22. The support arm 20 is structured to support a mass and may be of any shape, such as, but not limited to, a peg (shown), a hook, a loop, or a yoke. The portion of the plastic shell 24 that acts as a base 22 has cavities structured to accommodate one or more support assembly magnetic member(s) 26 therein. While the base 22 and the support assembly magnetic member 26 may have any shape, the support assembly magnetic member 26 preferably has a height (from the back surface of the base 22 to the outer side of the base 22) of between about 0.10 inch and 0.25 inch, and more preferably, about 0.19 inch, and a width of between about 0.38 inch and 0.75 inch, and more preferably, about 0.50 inch. The plastic shell 24 may encapsulate the support assembly magnetic member 26, but in the preferred embodiment, the support assembly magnetic member 26 has an exposed face which, preferably, defines the back surface of the at least one support assembly 14. The exposed face of the support assembly magnetic member 26, or the back side of the base 22, acts as an attachment surface 28. The generally planar magnetic member 12 and the support assembly magnetic member 26 are cooperative magnetic members 12, 26, and the support assembly magnetic member attachment surface 28 is structured to be magnetically coupled to the generally planar magnetic member attachment surface 16. Thus, when the generally planar magnetic member attachment surface 16 and the support assembly magnetic member attachment surface 28 engage each other, the cooperative magnetic members 12, 26 are coupled by magnetic attraction.

Further, the support assembly base 22 includes at least one protuberance interface 27 structured to engage the at least one protuberance 18. That is, the support assembly base 22, preferably, includes a protuberance interface 27 extending generally horizontally across the support assembly base 22 and which engages the at least one protuberance 18 over substantially the entire length of the protuberance interface 27. When the at least one protuberance 18 engages substantially the length of the protuberance interface 27, the at least one support assembly 14 is less likely to pivot or rotate when the at least one support assembly 14 engages the at least one protuberance 18. The protuberance interface 27 may be the bottom surface of the support assembly base 22 or a support assembly base attachment surface notch 64 (discussed below). When the protuberance interface 27 is the bottom surface of the support assembly base 22, the protuberance interface 27 is, preferably, angled to correspond to the shape of the upper face 17 (discussed below) of the at least one protuberance 18. As noted below, the at least one protuberance upper face 17 may be angled downwardly, that is, more than ninety degrees from vertical, generally perpendicular to vertical, or upwardly, that is, less than ninety degrees from vertical. Thus, the protuberance interface 27 may have a corresponding downwardly angled bottom surface, a generally perpendicular lower surface, or an upwardly angled bottom surface.

The at least one protuberance 18 is structured to resist motion, more specifically, a descending sliding motion, between the at least one support assembly 14 and the generally planar magnetic member 12 when the at least one support assembly 14 is coupled to the generally planar magnetic member 12 with the cooperative magnetic members 12, 26 engaging each other, and when the support assembly 14 is supporting a mass, the mass being sufficient to overcome the starting friction between the at least one support assembly 14 and the generally planar magnetic member 12. As stated, the at least one protuberance 18 is structured to resist a descending sliding motion of the at least one support assembly 14. Thus, the at least one support assembly 14 must be magnetically coupled to the generally planar magnetic member 12 at a location above the at least one protuberance 18. The at least one protuberance 18 has a perpendicular offset 30, indicated by the arrow in the Figures, extending a distance normal to the plane of the sheet 13. The offset 30, preferably, extends between about 0.10 and 0.5 inch and more preferably, about 0.30 inch, off the plane of the metal sheet 13. Preferably, the at least one protuberance 18 is elongated and extends in a substantially horizontal direction over the generally planar magnetic member attachment surface 16 and includes an upper face 17.

The at least one protuberance 18 may be a deformation 40 in the generally planar magnetic member attachment surface 16 and/or an elongated magnetic member 43 having an attachment surface 44. Where the at least one protuberance 18 is a deformation 40, the metal sheet 13 is crimped, bent, or otherwise deformed, so that the deformation 40 defines the at least one protuberance 18. That is, the at least one protuberance 18 may be a deformation forming a ridge 46 extending generally horizontally across the generally planar magnetic member attachment surface 16 and projecting generally perpendicular from the plane of said generally planar magnetic member 12. The ridge 46 may have a substantially horizontal upper face 48, or an angled upper face 50, relative to the plane of the generally planar magnetic member attachment surface 16. The shape of the ridge 46 may be based on aesthetics and/or the nature of the sheet 13. For example, a sheet 13 of a magnetic rubber material may not easily bend to a ninety degree angle. As such, a ridge 46 having an angled upper face 50 would be easier to form. The support assembly base 22, preferably, has a shape that corresponds to the shape of the ridge upper face 48, 50.

Alternatively, the deformation 40 may be a lip 60 having an associated cutout 62. That is, a generally horizontal cut may be made in the sheet 13. The tips of the horizontal cut include relatively-small, vertical cuts of at least the thickness of the sheet 13 and preferably slightly longer. In this configuration, the material of the sheet 13 adjacent to the cut may be lifted out of the plane of the sheet 13, thereby forming the lip 60. In one embodiment, the lip 60 is disposed below the cutout 62 and is a lower lip 63. Preferably, the lower lip 63 extends outwardly at an angle between about perpendicular to the generally planar magnetic member 12 to about ten degrees from vertical. Such a lower lip 63 acts as a protuberance 18 against which a support assembly 14 may rest. However, in a preferred embodiment, the at least one support assembly base attachment surface 28 includes a generally horizontal notch 64 extending thereacross. The notch 64 is sized and shaped to correspond to the shape of the lower lip 63. In this configuration, the support assembly base attachment surface notch 64 is structured to engage the lower lip 63 in a tongue-and-groove manner.

As shown in FIG. 3, the lip 60 may be an upper lip 65 having an associated cutout 62. Again, a generally horizontal cut may be made in the sheet 13. The tips of the horizontal cut include relatively-small, vertical cuts about the thickness of the sheet 13. In this configuration, the material of the sheet 13 adjacent to the cut may be lifted out of the plane of the sheet 13, thereby forming the upper lip 65. In this embodiment, the upper lip 65, as the name implies, is disposed above the associated cutout 62. Further, the upper lip 65 preferably includes an outwardly extending portion 66, which extends either horizontally or is downwardly angled, and a downwardly extending vertical portion 68. In this configuration, the upper lip 65 acts as a protuberance 18 for a support assembly 14 disposed thereabove. Further, the upper lip 65 forms a pocket 70 into which the upper edge of a support assembly 14, or an additional tab 72 extending upwardly from the support assembly base 22, may be inserted. This configuration is useful for a support assembly 14 having an extended support arm 20. When a tool, or other mass, is hung from an extended support arm 20, a substantial torque may be created at the interface between the cooperative magnetic members 12, 26. This torque may be strong enough to overcome the magnetic attraction between the cooperative magnetic members 12, 26 and cause the cooperative magnetic members 12, 26 to separate. To prevent this, the upper edge of a support assembly 14, or an additional tab 72 extending upwardly from the support assembly base 22, is inserted into the pocket 70 as described above. Once a portion of the support assembly 14 is in the pocket 70, the pocket 70 captures the support assembly 14 and prevents the separation of the cooperative magnetic members 12, 26. Preferably, a second protuberance 18 is disposed an appropriate distance below the upper lip 65 to support the support assembly 14 from below.

As an alternative to a deformation 40 in the generally planar magnetic member attachment surface 16, the at least one protuberance 18 may be a separate elongated member 42 that is coupled to the generally planar magnetic member 12. Preferably, the separate elongated member 42 is an elongated magnetic member 43 having an attachment surface 44. The elongated magnetic member attachment surface 44 is structured to be magnetically coupled to the generally planar magnetic member 12. The elongated magnetic member 43 is simply a magnetic member 12 having a cooperative relationship with the generally planar magnetic member 12. The elongated magnetic member 43, preferably, has a thickness corresponding to a minimal offset 30. Thus, the weight of the elongated magnetic member 43 is minimal. The elongated magnetic member 43 is magnetically coupled to the generally planar magnetic member 12 and oriented to extend generally horizontally. This type of protuberance 18 has the advantage of being movable. That is, if the protuberance 18 is not in a desired location, the user may simply detach, or slide, the elongated magnetic member 43 to a different location on the generally planar magnetic member 12. Alternatively, the separate elongated member 42 may be attached by another means, such as, but not limited to, an adhesive, fasteners, welding, or other known means. If such an alternate attachment means is used, a non-magnetic elongated member (not shown) may be used.

The elongated magnetic member 43 may also be formed with an upper lip 63A. That is, a longitudinal edge of the elongated magnetic member 43 may be bent so as to extend outwardly/upwardly from the plane of the generally planar magnetic member 12. As with the embodiment described above, the upper lip 63A may engage a notch 64 in the at least one support assembly base 22. The elongated magnetic member 43 may also be formed with a lower lip (not shown) that forms a pocket 70 relative to the portion of the generally planar magnetic member 12 disposed below the elongated magnetic member 43 in a manner similar to the pocket 70 described above. Such an elongated magnetic member 43 with a lower lip is structured to support high torque/heavy loads.

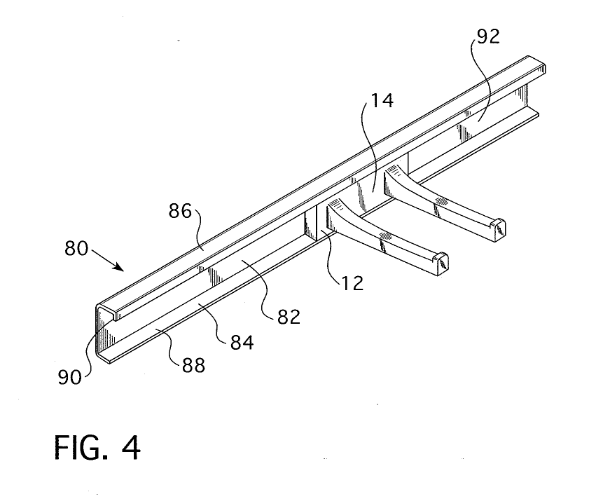

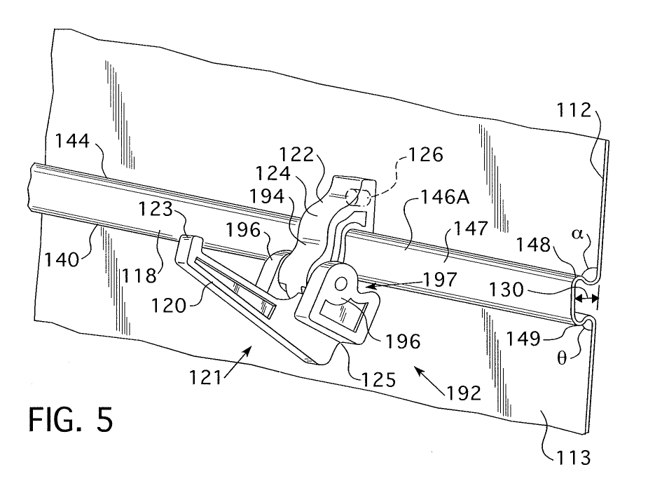

In another embodiment, the generally planar magnetic member 12 may be shaped as channel magnetic member 80, as shown in FIG. 4. As described below, the channel magnetic member 80 has a generally “C-shaped” cross-section. As it is generally difficult to incorporate this shape into a sheet metal panel, this embodiment is disclosed as having a single channel magnetic member 80. However, it is understood that, while difficult to form this shape in sheet metal, it is not impossible and the generally planar magnetic member 12 may incorporate more than the disclosed, single channel magnetic member 80. For example, multiple channel magnetic member 80 may be attached (not shown) to a sheet 13 whereby each channel magnetic member 80 acts as a protuberance 18. The channel magnetic member 80 is, preferably, coupled directly to a wall and is structured to support high torque/heavy loads.

In this embodiment, the channel magnetic member 80 includes a body 82 having an elongated generally planar base portion 84, a first, upper depending sidewall 86 extending generally perpendicularly to the base portion, a second, lower depending sidewall 88 extending generally perpendicularly to the base portion 84, and one overhanging lip 90. The overhanging lip 90 extends downwardly from the first, upper depending sidewall 86 and is, preferably, generally parallel to the base portion 84. In this configuration, the channel magnetic member 80 forms a channel with an overhanging lip 90. It is further noted that the channel magnetic member 80 does not have a lip extending upwardly from the lower depending sidewall 88. Thus, the lower depending sidewall 88 acts as the at least one protuberance 18 and may engage any support assembly 14 disposed thereabove and prevent the support assembly 14 from sliding down, or off, the planar magnetic member 12.

A support assembly 14, as described above, is structured to be disposed, and captured, within the magnetic channel member 80. That is, the support assembly base 22 is sized to be disposed between the first, upper depending sidewall 86 and the second, lower depending sidewall 88 with the support assembly base 22 extending substantially between the first, upper depending sidewall 86 and the second, lower depending sidewall 88. In this configuration, the upper, outer edge of the support assembly base 22 will contact, or be disposed immediately adjacent to, the overhanging lip 90. Thus, the support assembly 14 is captured by the elongated magnetic channel member body 82. When a heavy tool, or other heavy item, is supported by the support assembly 14, the torque created thereby will tend to cause the upper edge of the support assembly base 22 to rotate away from the magnetic channel member 80; however, the upper edge of the support assembly base 22 is held in place by the overhanging lip 90. That is, the upper edge of the support assembly base 22 is biased against the overhanging lip 90.

It is noted that the magnetic channel member 80 substantially traps the support assembly 14 within the defined channel. As such, an alternate, non-magnetic support (not shown) may be utilized. However, as the magnetic channel member 80 does not have a lip extending upwardly from the lower depending sidewall 88, an unused or unencumbered support assembly 14 would not have the upper edge of the support assembly base 22 biased against the overhanging lip 90 and may be too loose to stay within the magnetic channel member 80. When the support assembly 14 includes the magnetic member 26, the magnetic member 26 aids in keeping an unencumbered support assembly 14 within the magnetic channel member 80.

It is noted that a single, generally planar magnetic member 12 may include two or more different types of protuberances 18. In a preferred embodiment, at least one protuberance 18 is selected from the group including: a deformation 40 in the sheet 13 of ferrous material and/or an elongated magnetic member 43 having an attachment surface.

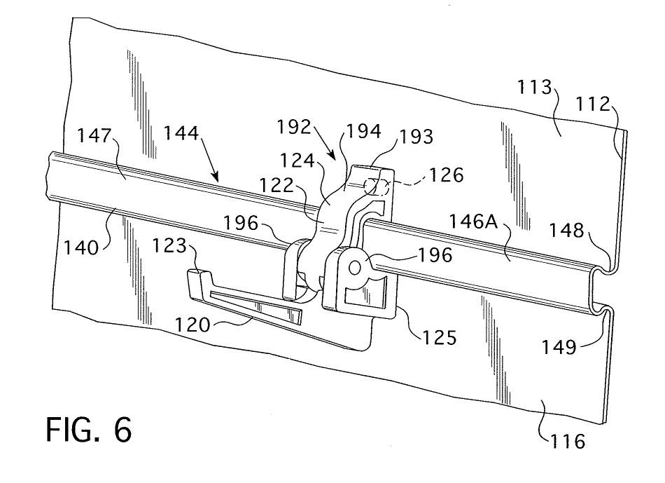

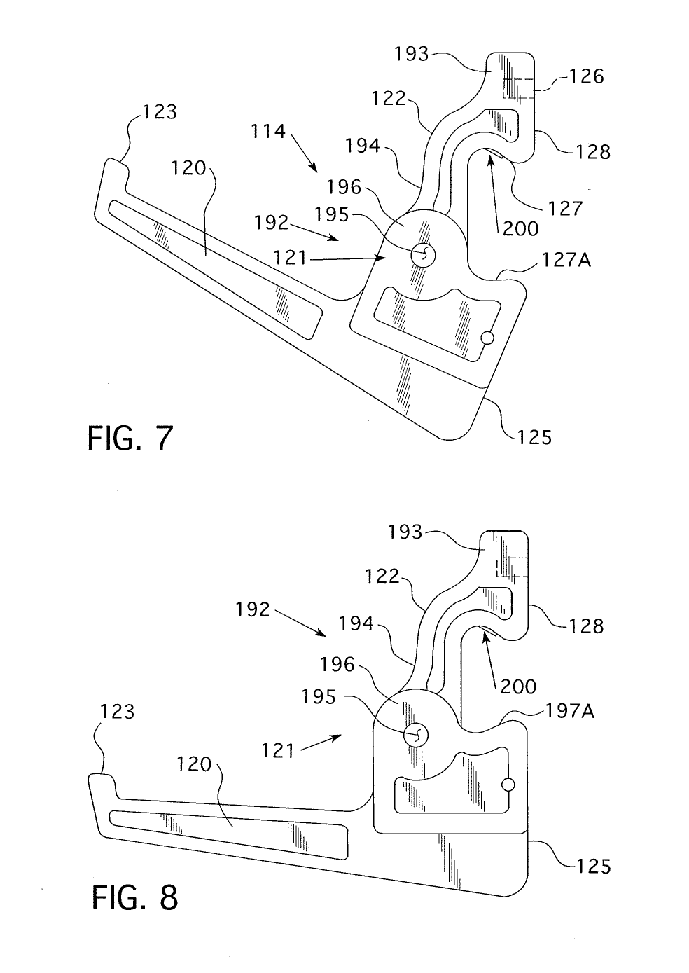

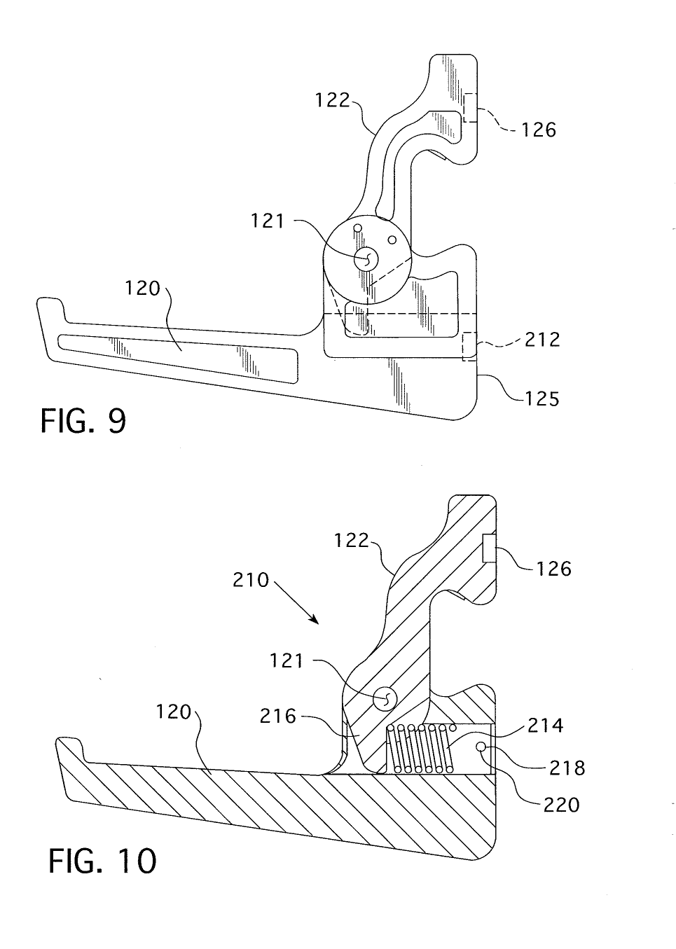

A further embodiment, shown in FIGS. 6-11 preferably utilize at least one support assembly 114 having support assembly magnetic member 126; however, in this embodiment, the at least one support assembly 114 also includes a clamp assembly 192. The clamp assembly 192 is structured to couple the at least one support assembly 114 to the generally planar member 112 without the aid of magnets. As this embodiment is similar to the embodiment described above, similar elements shall be identified by reference numbers, except increased by 100. Thus, the at least one support assembly 14 identified above by reference number 14 is, for this embodiment, identified by reference number 114. Accordingly, elements of the embodiment discussed below may not be specifically described before being referenced. It is understood that such elements are similar to the elements in the embodiment described above. That is, unless otherwise noted, elements from the embodiment described above are substantially similar to the elements in the embodiment described below.

Before discussing the clamp assembly 192, it is noted that for this embodiment, the at least one protuberance 118 is, preferably a deformation 140 in the generally planar magnetic member attachment surface 116 and/or an elongated magnetic member (not shown) having an attachment surface 144. Where the at least one protuberance 118 is a deformation 140, the metal sheet 113 is crimped, bent, or otherwise deformed, so that the deformation 140 defines the at least one protuberance 118. That is, the at least one protuberance 118 may be a deformation forming a ridge 146 extending generally horizontally across the generally planar magnetic member attachment surface 116. Unlike the embodiment discussed above, however, in this embodiment, the ridge upper face 148 is preferably at an acute angle \acute{α}, i.e., extending upwardly at an angle less than ninety degrees from vertical. Further, as will be described below, the clamp assembly 192 also engages the ridge lower face 149. Accordingly, the ridge lower face 149 is, preferably, at an acute angle θ, i.e., extending downwardly at an angle less than ninety degrees from vertical. Further, for aesthetic reasons, it is preferred that the ridge upper face 148 and the ridge lower face 149 extend at generally the same angle, but in opposite directions. Hereinafter, a ridge 146 having an angled upper face 148 and an angled ridge lower face 149 shall be identified as a “double taper ridge” 146A. The double taper ridge 146A also has a vertical face 147 disposed between the ridge upper face 148 and the ridge lower face 149. In another departure from the embodiment described above, a double taper ridge 146A has an offset 130 that, preferably, extends between about 0.10 and 0.50 inch and more preferably, about 0.33 inch, off the plane of the metal sheet 113, as measured from the front face of the generally planar magnetic member attachment surface 116 to the vertical face 147 (discussed below) of the double taper ridge.

As with the prior embodiment, the at least one support assembly 114 includes a support arm 120 and a base 122. However, in this embodiment, the at least one support assembly 114 also includes a hinge 121. The support assembly support arm 120 and the support assembly base 122 are pivotally coupled by the hinge 121. The three elements, support assembly support arm 120, support assembly hinge 121 and the support assembly base 122 form the clamp assembly 192.

The support assembly base 122, again, is preferably formed from a plastic shell 124 enclosing at least one support assembly magnetic member 126. However, in this embodiment, the support assembly base 122 has an upper portion 193 and a descending arm 194. The at least one support assembly magnetic member 126 is disposed within the support assembly base upper portion 193. The support assembly base upper portion 193 also defines the protuberance interface 127. That is, the lower side of the support assembly base upper portion 193 is shaped, i.e., angled, to generally correspond to, and engage, the double taper ridge upper face 148. The support assembly base descending arm 194 extends downwardly from the most offset portion of the support assembly base upper portion 193. That is, relative to the double taper ridge 146A, the support assembly base descending arm 194 is structured to extend over the double taper ridge vertical face 147. Thus, in this configuration, the support assembly base upper portion 193 is structured to generally fit within the channel defined by the plane of the metal sheet 113 and the double taper ridge upper face 148, while the support assembly base descending arm 194 extends over the double taper ridge vertical face 147.

It is noted that, as with the prior embodiment, the exposed face of the support assembly magnetic member 126, or the back side of the base 122, acts as an attachment surface 128. The generally planar magnetic member 112 and the support assembly magnetic member 126 are cooperative magnetic members 112, 126, and the support assembly magnetic member attachment surface 128 is structured to be magnetically coupled to the generally planar magnetic member attachment surface 116. Thus, when the generally planar magnetic member attachment surface 116 and the support assembly magnetic member attachment surface 128 engage each other, the cooperative magnetic members 112, 126 are coupled by magnetic attraction.

The support assembly support arm 120 has a distal end 123 and a proximal end 125. The support arm distal end 123 is structured to support a mass and may be of any shape, such as, but not limited to, a peg (shown), a hook, a loop, or a yoke. The upper surface of the support arm proximal end 125 also defines a protuberance interface 127A. The support arm proximal end protuberance interface 127A is shaped, i.e., angled, to generally correspond to, and engage, the double taper ridge lower face 149. It is further noted that the location of the support assembly hinge 121, discussed below, is between the support arm distal end 123 and the support arm proximal end 125. In this configuration, a rotation of the support assembly support arm 120 causes the respective ends 123, 125 to move in opposite directions about the support assembly hinge 121 axis. That is, when the support arm distal end 123 is rotated, or biased, downwardly, the support arm proximal end 125 is rotated, or biased, upwardly.

The support assembly hinge 121 pivotally couples the support assembly support arm 120 and support assembly base 122. As set forth below, elements of the support assembly hinge 121 may be incorporated into both the support assembly support arm 120 and the support assembly base 122. The axis of the support assembly hinge 121 extends in a generally horizontal direction and generally in a direction that is parallel to the plane of the metal sheet 113. The support assembly hinge 121 is preferably disposed at the lower end of the support assembly base descending arm 194. As shown in the figures, the support assembly hinge 121 is created by a generally horizontal opening 195 extending through the support assembly base descending arm 194, a clevis 196 with generally aligned openings 197 disposed on the support arm proximal end 125, and a pin (not shown). The support assembly hinge 121 is assembled when the support arm proximal end clevis 196 is disposed about the support assembly base descending aim 194 so that the support assembly base descending arm opening 195 and the support arm proximal end clevis openings 197 are aligned. The hinge pin is then inserted through the three openings 195, 197. Of course, the support assembly hinge 121 may be any type of common hinge, e.g., a clevis could be disposed on the support assembly base descending arm 194, and a single opening my be located in the support arm proximal end 125. The support assembly hinge 121 may also be a living hinge (not shown).

When the clamp assembly 192 is assembled as described above, the clamp assembly 192 operates as follows. The at least one support assembly 114 is structured to move between an open, first position, wherein the support arm proximal end protuberance interface 127A is rotated away from the support assembly base upper portion protuberance interface 127, and a closed, second position, wherein the support arm proximal end protuberance interface 127A is rotated toward the support assembly base upper portion protuberance interface 127.

The at least one support assembly 114 having a clamp assembly 192 is coupled to the generally planar magnetic member 112, and more specifically to the double taper ridge 146A as follows. With the clamp assembly 192 being in the open position, the support assembly base upper portion 193 is positioned above the double taper ridge 146A and moved into engagement with the generally planar magnetic member 112. When the back side of the support assembly base 122 engages the generally planar magnetic member 112, the support assembly magnetic member 126 magnetically couples the at least one support assembly 114 and the generally planar magnetic member 112, as described above. The support assembly base upper portion 193 is moved downwardly until the support assembly base upper portion protuberance interface 127 engages the double taper ridge upper face 148. The clamp assembly 192 is then moved into the second position. As the clamp assembly 192 is being moved into the second position, the support arm proximal end protuberance interface 127A moves into engagement with the double taper ridge lower face 149. Thus, when the clamp assembly 192 is in the second position, the support assembly base upper portion protuberance interface 127 and the support arm proximal end protuberance interface 127A engage the upper and lower faces 148, 149 of the double taper ridge 146A. Thus, the clamp assembly 192 is structured to engage the double taper ridge 146A in a clamping manner. In this position, the at least one support assembly 114 having a clamp assembly 192 may not be moved away from the generally planar magnetic member 112.

Further, when a tool, or other object, is supported by the support assembly support arm 120, the weight of the tool biases the support arm distal end 123 downwardly. As noted above, due to the position of the support assembly hinge 121 between the support arm distal end 123 and the support aim proximal end 125, the weight of the tool also biases the support arm proximal end 125 upwardly. Thus, the weight of the tool causes the support arm proximal end protuberance interface 127A to be biased against the double taper ridge lower face 149. This additional clamping force ensures that the at least one support assembly 114 cannot be removed from the generally planar magnetic member 112.

Use of the clamp assembly 192 may be enhanced by providing elements structured to maintain the clamp assembly 192 in either, or both, of the first and second positions. That is, as noted immediately above, when the at least one support assembly 114 is supporting a tool or object, the at least one support assembly 114 has an enhanced clamping force. Such an enhanced clamping force would be useful even if the at least one support assembly 114 is empty. Accordingly, the clamp assembly 192 may also include a clamp assembly bias device 210 structured to, preferably, bias the clamp assembly to the closed, second position. In one embodiment, the clamp assembly bias device 210, shown in FIG. 9, includes a cooperative magnetic member 212 disposed at, or adjacent to, the support arm proximal end 125. At this location, the clamp assembly bias device cooperative magnetic member 212 is structured to magnetically couple the support assembly support arm 120 to the generally planar magnetic member 112 when the at least one support assembly 114 is in the closed, second position.

The clamp assembly bias device 210 may also utilize a spring 214 structured to bias the clamp assembly 192 to the second position. That is, as shown in FIG. 10, the support assembly base descending arm 194 includes a spring tab 216 extending beyond the support assembly hinge 121. As shown, the spring tab 216 extends between the sides of the support arm proximal end clevis 196. Further, the support assembly support arm 120 includes a spring support 218. As shown the support assembly support arm spring support 218 is a rod 220 extending between the sides of the support arm proximal end clevis 196. In this configuration, a compression spring 214 may be disposed between the spring tab 216 and the spring support 218. The force of the compression spring 214 biases the support assembly support arm 120 and support assembly base 122 to the closed, second position.

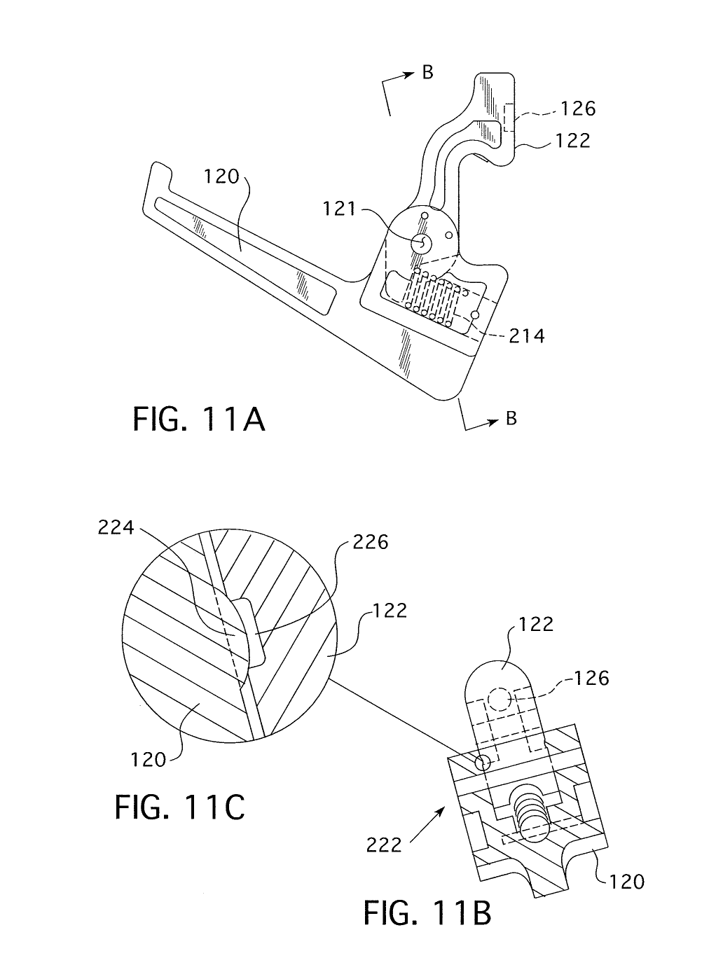

The clamp assembly 192 may also include a positioning device 220 structured to temporarily maintain the clamp assembly 192 in the open, first position. That is, especially in the embodiment of the clamp assembly bias device 210 having a spring 214, it may be inconvenient for the user to hold the at least one support assembly 114 in the first position while installing the at least one support assembly 114. The clamp assembly bias device positioning device 220 provides this function. As shown in FIGS. 11A-11C, the clamp assembly bias device positioning device 220 may be a ball-and detent assembly 222 having, as shown, a ball 224 disposed on the support arm proximal end clevis 196 and a detent 226 disposed on the support assembly base 122. The ball-and detent assembly 222 is disposed at the interface of the support assembly support arm 120 and the support assembly base 122. The ball-and detent assembly 222 elements are positioned so that the ball 224 engages the detent 226 when the clamp assembly 192 is in the first position.

The clamp assembly bias device positioning device 220 is structured to provide a locking force that is greater than the biasing force created by the clamp assembly bias device 210. Thus, the user may move the clamp assembly 192 into the first position, whereupon the clamp assembly bias device positioning device 220 maintains the clamp assembly 192 in this position. Once the at least one support assembly 114 is positioned on the double taper ridge 146A, the user moves the clamp assembly 192 out of the first position and, as the clamp assembly 192 moves into the second position, the clamp assembly bias device 210 becomes effective and helps maintain the clamp assembly 192 in the second position.

It is further noted that the at least one support assembly 114 having a clamp assembly 192 may be functional without having a support assembly magnetic member 126. The magnetic coupling created by the support assembly magnetic member 126 and the generally planar magnetic member 112 acts to resist the separation of the support assembly base 122 from the generally planar magnetic member 112. This force is useful when the angle of the double taper ridge upper face 148 is shallow, i.e., about horizontal. That is, depending upon several factors, such as, but not limited to, the weight of the at least one support assembly 114 and the coefficient of friction between the support assembly base upper portion protuberance interface 127 and the double taper ridge upper face 148, when the angle of the double taper ridge upper face 148 is shallow, the weight of the at least one support assembly 114 (and the torque created by the weight of the support assembly support arm 120) may cause the support assembly base upper portion protuberance interface 127 to slide over the double taper ridge upper face 148 and allow the at least one support assembly 114 to separate from the generally planar magnetic member 112. The magnetic coupling created by the support assembly magnetic member 126 and the generally planar magnetic member 112 acts to resist this separation.

However, when the angle of the double taper ridge upper face 148 is not shallow, preferably between about 10° and 45°, and more preferably about 25°, the angle of the interface between the support assembly base upper portion protuberance interface 127 and the double taper ridge upper face 148 is too steep to allow the support assembly base upper portion protuberance interface 127 to slide over the double taper ridge upper face 148. Thus, provided the angle of the double taper ridge upper face 148 is not shallow, the at least one support assembly 114 having a clamp assembly 192 may be functional without having a support assembly magnetic member 126.

Further, the angle of the double taper ridge upper face 148 may be made more shallow if the coefficient of friction between the support assembly base upper portion protuberance interface 127 and the double taper ridge upper face 148 is increased. As is known in the art, this may be accomplished in many ways, such as, but not limited to, providing a course surface on either, and preferably both, the support assembly base upper portion protuberance interface 127 and the double taper ridge upper face 148. Accordingly, at least one of the support assembly base upper portion protuberance interface 127 and the double taper ridge upper face 148 may include a friction enhancement device 200 structured to increase the coefficient of friction between the support assembly base upper portion protuberance interface 127 and the double taper ridge upper face 148. Of course, in this embodiment the generally planar member 112A does not have to be magnetic, and the assembly is simply and organizer 110 rather than a magnetic organizer 10.

It is further noted that the embodiment of the clamp assembly bias device 210 that utilizes a spring 214 as well as the positioning device 220, both described above, may be used in the non-magnetic embodiment of the at least one support assembly 114. While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A magnetic organizer comprising:
a generally planar magnetic member having an attachment surface, said attachment surface having at least one protuberance thereon;
said generally planar magnetic member extending in a generally vertical plane;
at least one support assembly having a base and a support arm extending therefrom, said base having a magnetic member therein, said support arm structured to support a mass;
said generally planar magnetic member and said support assembly base magnetic member being cooperative magnetic members; and
said at least one protuberance being structured to resist motion between said at least one support assembly and said generally planar magnetic member when said at least one support assembly is coupled to said generally planar magnetic member with said cooperative magnetic members engaging each other, and when said support assembly is supporting a mass, said mass being sufficient to overcome the starting friction between said at least one support assembly and said generally planar magnetic member.

2. The magnetic organizer of claim 1 wherein:
said at least one protuberance includes an upper face;
said support assembly base has at least one protuberance interface, said at least one protuberance interface structured to engage the at least one protuberance; and
wherein, when said at least one support assembly engages said protuberance, substantially the entire length of said protuberance interface engages said protuberance upper face.

3. The magnetic organizer of claim 1 wherein:
said generally planar magnetic member being a sheet of material, said sheet having deformations therein, said deformations forming said attachment surface at least one protuberance.

4. The magnetic organizer of claim 3 wherein:
said deformation is a ridge extending generally horizontally across said generally planar magnetic member attachment surface;
said ridge having an angled upper face extending at an angle relative to the plane of said generally planar magnetic member;
said support assembly base has at least one protuberance interface, said at least one protuberance interface structured to engage said ridge; and
wherein, when said at least one support assembly engages said ridge, substantially the entire length of said protuberance interface engages said ridge upper face.

5. The magnetic organizer of claim 3 wherein:
said deformation is a ridge extending generally horizontally across said generally planar magnetic member attachment surface; and
said ridge having a horizontal upper face extending generally perpendicularly to the plane of said generally planar magnetic member.

6. The magnetic organizer of claim 3 wherein:
said deformation is a lip, having an associated cutout extending generally horizontally, projecting from said attachment surface.

7. The magnetic organizer of claim 6 wherein:
said lip is a lower lip disposed below said cutout;
said lower lip extending outwardly at an angle between about 10 degrees from vertical and about 90 degrees from vertical;
said at least one support assembly base includes an attachment surface;
said at least one support assembly base attachment surface structured to engage said generally planar magnetic member attachment surface and having a generally horizontal notch extending thereacross; and
said at least one support assembly base attachment surface notch structured to engage said lower lip in a tongue-and-groove manner.

8. The magnetic organizer of claim 6 wherein:
said lip is an upper lip disposed above said cutout; and
said upper lip having an outwardly extending portion and a downwardly extending vertical portion, said upper lip forming a pocket.

9. The magnetic organizer of claim 1 wherein:
said generally planar magnetic member includes a generally flat sheet of material; and
said at least one protuberance being at least one separate elongated member coupled to said generally flat sheet of material.

10. The magnetic organizer of claim 9 wherein:
said generally planar magnetic member includes a generally flat sheet of material;
said at least one separate elongated member being at least one elongated magnetic member having an attachment surface;
said generally planar magnetic member and said at least one elongated magnetic member being cooperative magnetic members; and
said at least one elongated magnetic member attachment surface magnetically coupled to said generally planar magnetic member attachment surface.

11. The magnetic organizer of claim 10 wherein:
said at least one elongated magnetic member includes an outwardly projecting, horizontally extending lip.

12. The magnetic organizer of claim 11 wherein:
said lower lip extending outwardly at an angle between about 10 degrees from vertical and about 90 degrees from vertical;
said at least one support assembly base includes an attachment surface;
said at least one support assembly base attachment surface structured to engage said generally planar magnetic member attachment surface and having a generally horizontal notch extending thereacross; and
said at least one support assembly base attachment surface notch structured to engage said lower lip in a tongue-and-groove manner.

13. The magnetic organizer of claim 11 wherein said lip is an upper lip having an outwardly extending portion and a downwardly extending vertical portion, said upper lip forming a pocket.

14. The magnetic organizer of claim 1 wherein:
said generally planar magnetic member is a channel magnetic member, said channel magnetic member having a body with an elongated generally planar base portion, a first, upper depending sidewall extending generally perpendicularly to said base portion, a second, lower depending sidewall extending generally perpendicularly to said base portion, and one overhanging lip, said overhanging lip extending downwardly from said first, upper depending sidewall, whereby said elongated magnetic channel body defines a channel;
said support assembly base being sized to be disposed between said first, upper depending sidewall and said second, lower depending sidewall with said support assembly base extending substantially between said first, upper depending sidewall and said second, lower depending sidewall; and
whereby when said support assembly is disposed in said channel magnetic member, said support assembly is captured by said channel magnetic member body.

15. The magnetic organizer of claim 1 wherein:
said generally planar magnetic member is a magnet; and
said at least one support assembly base magnetic member is a sheet of ferrous material.

16. The magnetic organizer of claim 1 wherein:
said generally planar magnetic member is a sheet of ferrous material; and
said at least one support assembly base magnetic member is a magnet.

17. The magnetic organizer of claim 1 wherein:
said at least one protuberance is selected from the group including: a deformation in said sheet of ferrous material and an elongated magnetic member having an attachment surface.

18. A support assembly for a magnetic organizer, said generally planar magnetic member extending in a generally vertical plane, said generally planar magnetic member having an attachment surface, said attachment surface having at least one protuberance thereon, said at least one protuberance extending generally horizontally on said generally planar magnetic member, said at least one protuberance having an upper face, said support assembly comprising:
a base and a support arm extending therefrom, said base having a magnetic member therein, said support arm structured to support a mass;
said support assembly base magnetic member being cooperative with said generally planar magnetic member;
said support assembly base having at least one protuberance interface, said at least one protuberance interface structured to engage said at least one protuberance.

19. The support assembly for a magnetic organizer of claim 18 wherein, said protuberance upper face is angled downwardly and wherein:
said at least one protuberance interface is the lower face of said base, said protuberance interface angled to correspond to said angle of said protuberance upper face.

20. The support assembly for a magnetic organizer of claim 18 wherein:
said support assembly base has an attachment surface structured to engage said generally planar magnetic member attachment surface; and
said protuberance interface is a generally horizontal notch extending across said support assembly base attachment surface.
